(19) United States
(12) Patent Application Publication
(10) Pub. No.: US 2006/0069608 A1
(43) Pub. Date: Mar. 30, 2006

(54) Computer product for outputting evaluation result

(75) Inventors: Masayuki Iguchi, Kawasaki (JP); Masao Ezawa, Kawasaki (JP); Tadashi Sato, Kawasaki (JP); Hiroyuki Ohara, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/109,850

(22) Filed: Apr. 20, 2005

(30) Foreign Application Priority Data
Sep. 29, 2004 (JP) 2004-284254

(51) Int. Cl. H04M 3/51

(52) U.S. Cl. 705/11

(57) ABSTRACT

A computer-readable recording medium stores a computer program for outputting an evaluation result of a target to be evaluated by positioning the target on a chart that is formed with a plurality of coordinate axes that determine an evaluation value of the target. The computer program makes a computer execute storing setting conditions of a specific area that indicates a specific target to be evaluated on the chart; and outputting the specific area and a position of coordinates of the target on the chart based on the setting conditions stored at the storing.

### BACKGROUND OF THE INVENTION

1) Field of the Invention

The present invention relates to a computer program to output evaluation result that outputs evaluation result of a target to be evaluated by positioning the target to be evaluated on a chart that is formed by a plurality of coordinate axes that determines an evaluation value of the target to be evaluated, and in particular to a computer program to output evaluation result that supports strongly a decision making by a user.

2) Description of the Related Art

In recent years, an importance of information technology (IT) systems that support corporate activities has been increasing more and more and continuous investment in IT has been becoming indispensable. Moreover, there has been an increase in number of application software that is used by a user and it is necessary to invest for their maintenance and management.

However, normally there is a limit to a budget that can be allocated to the investment in IT. Therefore, a method called as a portfolio management has been used for analyzing and evaluating the allocation of investment for construction and maintenance of an IT system.

In the portfolio management, an investment item is evaluated by using a variety of evaluation items. Then, a score is assigned to an evaluation of each evaluation item and a position of the investment item is displayed on a portfolio chart in which each evaluation item is an axis of coordinates (see, for example, Japanese Patent Application Laid-open Publication No. 2001-357197). By this, the user can understand at a glance, the evaluation of the investment item made from a plurality of angles.

Moreover, a system for making a sales-information portfolio that displays a position of each product advertisement in a portfolio chart in which an area of appearance of the product advertisement and a sales number are let to be coordinate axes has been proposed (see, for example, Japanese Patent Application Laid-open Publication No. 2001-216362) to enable to understand easily how the area of appearance of the product advertisement effects the sales.

However, in conventional technologies mentioned above, although it is possible to understand an evaluation that has been performed from a plurality of angles of an investment item or an effect of an area of appearance of a product advertisement on the sales, in a portfolio chart at a glance, it has been difficult to support so that a decision making by a user is performed smoothly.

Concretely, in a case of determining the investment item or in a case of publishing the product advertisement, although there are various constraints, a problem is that it has been difficult for the user to judge as to which is an item to be invested in on priority basis or as to what is a suitable area of appearance of the product advertisement for publishing the product advertisement, while taking into consideration the constraints.

Therefore, as to how the decision making by the user can be supported as strongly as possible based on the portfolio chart that is drawn according to a portfolio management method while taking into consideration the above mentioned constraints, has become an important issue.

### SUMMARY OF THE INVENTION

It is an object of the present invention to solve at least the above problems in the conventional technology.

A computer-readable recording medium according to one aspect of the present invention stores a computer program for outputting an evaluation result of a target to be evaluated by positioning the target on a chart that is formed with a plurality of coordinate axes that determine an evaluation value of the target. The computer program makes a computer execute storing setting conditions of a specific area that indicates a specific target to be evaluated on the chart; and outputting the specific area and a position of coordinates of the target on the chart based on the setting conditions stored at the storing.

An apparatus according to another aspect of the present invention, which is for outputting an evaluation result of a target to be evaluated by positioning the target on a chart that is formed with a plurality of coordinate axes that determine an evaluation value of the target, includes a setting-condition storing unit that stores setting conditions of a specific area that indicates a specific target to be evaluated on the chart; and an area output unit that outputs the specific area and a position of coordinates of the target on the chart based on the setting conditions stored at the storing.

A method according to still another aspect of the present invention, which is for outputting an evaluation result of a target to be evaluated by positioning the target on a chart that is formed with a plurality of coordinate axes that determine an evaluation value of the target, includes storing setting conditions of a specific area that indicates a specific target to be evaluated on the chart; and outputting the specific area and a position of coordinates of the target on the chart based on the setting conditions stored at the storing.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an illustration describing evaluation result output process according to the present invention;

FIG. 2 is a diagram showing functional configuration of an evaluation result output unit according to the present embodiment;

FIG. 3 is a diagram showing an example of query data 12a shown FIG. 2;

FIG. 4 is a diagram showing an example of score setting data 12b shown in FIG. 2;

FIG. 5 is a diagram showing an example of weight coefficient data 12 shown in FIG. 2;

FIG. 6 is a diagram showing an example of score data 12d;

FIG. 7 is a diagram showing an example of item data 12e shown in FIG. 2;

FIG. 8 is a diagram showing an example of display condition holding data 12f shown in FIG. 2;

FIG. 9 is a diagram showing an example of conditional expression data 12g shown in FIG. 2;

FIG. 10A is a diagram (1) showing an example of an output of a query item;

FIG. 10B is a diagram (2) showing an example of the output of the query item;

FIG. 10C is a diagram (3) showing an example of the output of the query item;

FIG. 11 is a diagram illustrating a skeleton display process and a non-display process;

FIG. 12 is a diagram illustrating a trajectory estimation process;

FIG. 13 is a diagram showing an example of item list 60;

FIG. 14 is a flow chart showing a processing procedure for calculating a score of each item;

FIG. 15 is a flow chart showing a processing procedure for drawing a portfolio chart;

FIG. 16 is a flow chart showing a processing procedure for a skeleton display process or a non-display process of a circle;

FIG. 17 is a flow chart showing a processing procedure for coloring process of the circle;

FIG. 18 is a flow chart showing a processing procedure for a process of returning to the display condition of the circle;

FIG. 19 is a flow chart showing a processing procedure for an anticipated trajectory drawing process;

FIG. 20 is a flow chart showing a processing procedure for a warning process based on an anticipated trajectory;

FIG. 21 is a flow chart showing a processing procedure for output process of item list 60;

FIG. 22 is a diagram showing a configuration of a computer system 100 that executes evaluation result output process; and

FIG. 23 is a block diagram showing a configuration of a main body according to the computer system 100 shown in FIG. 22.

### DETAILED DESCRIPTION

Exemplary embodiments of a computer program for outputting an evaluation result according to the present invention are described below in detail with reference to the accompanying drawings. In a following embodiment, a case of using the computer program to output evaluation result for a decision making about an investment for an IT system is described. However, the present invention is not restricted to the IT system and can be used for supporting strongly a decision making about an investment for an application etc. and a decision making about determining an evaluation value of a target to be evaluated of an enterprise and an individual.

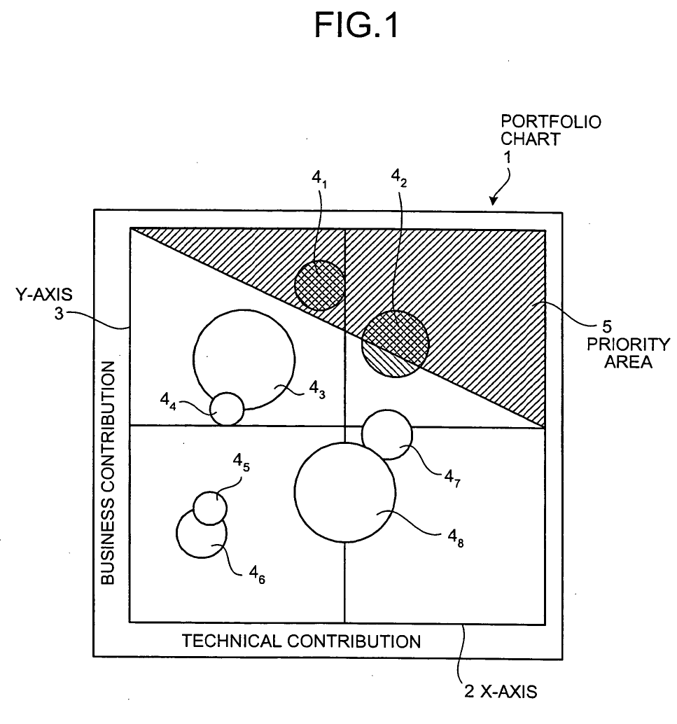

FIG. 1 is an illustration describing the evaluation result output process according to the present invention. As shown in FIG. 1, in the evaluation result output process, circles 4₁ to 4₈ that show evaluation of each investment item are positioned on a portfolio flow chart 1 with a technical contribution on an X-axis 2 and a business contribution on a Y-axis 3.

Central coordinates of these circles 4₁ to 4₈ indicate a value of the business contribution and a value of the technical contribution that are evaluated for each of the investment items.

In this portfolio chart 1, since each investment item can be compared with the same standards viz. the technical contribution and the business contribution, a user can perform objectively the decision making about the investment.

Moreover, in the evaluation result output process, if a condition with which the investment is to be done on priority basis is set, a priority area 5 corresponding to that condition is drawn on the portfolio chart 1 by using a polygon or a straight line.

This enables to understand at a glance a condition in the investment item displayed by circles 4₁ to 4₈ on the portfolio chart 1 with which the investment is to be done on priority basis, thereby enabling to support strongly the decision making about the investment.

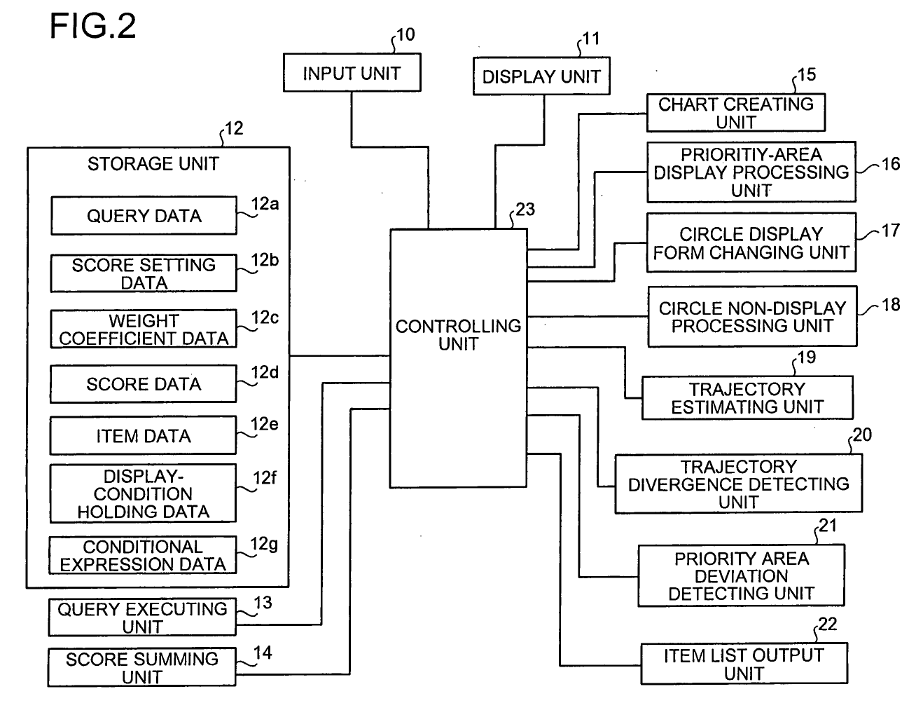

FIG. 2 is a diagram showing the functional configuration of the evaluation result output unit according to the present embodiment. As shown in FIG. 2, this evaluation result output unit has an input unit 10, a display unit 11, a storage unit 12, a query executing unit 13, a score summing unit 14, a chart creating unit 15, a priority-area display processing unit 16, a circle display form changing unit 17, a circle non-display processing unit 18, a trajectory estimating unit 19, a trajectory divergence detecting unit 20, a priority-area deviation detecting unit 21, an item list output unit 22, and a controlling unit 23.

The input unit 10 is an input device such as a key board and a mouse. The display unit 11 is a display device such as a display. The storage unit 12 is a storage device such as a hard disc drive. This storage unit 12 stores query data 12a, score setting data 12b, weight coefficient data 12c, score data 12d, item data 12e, display condition holding data 12f, and conditional expression data 12g.

The query data 12a is data in which query items made to a person in charge of investment item for evaluating business contribution and technical contribution of each investment item, and options of a reply to the query item.

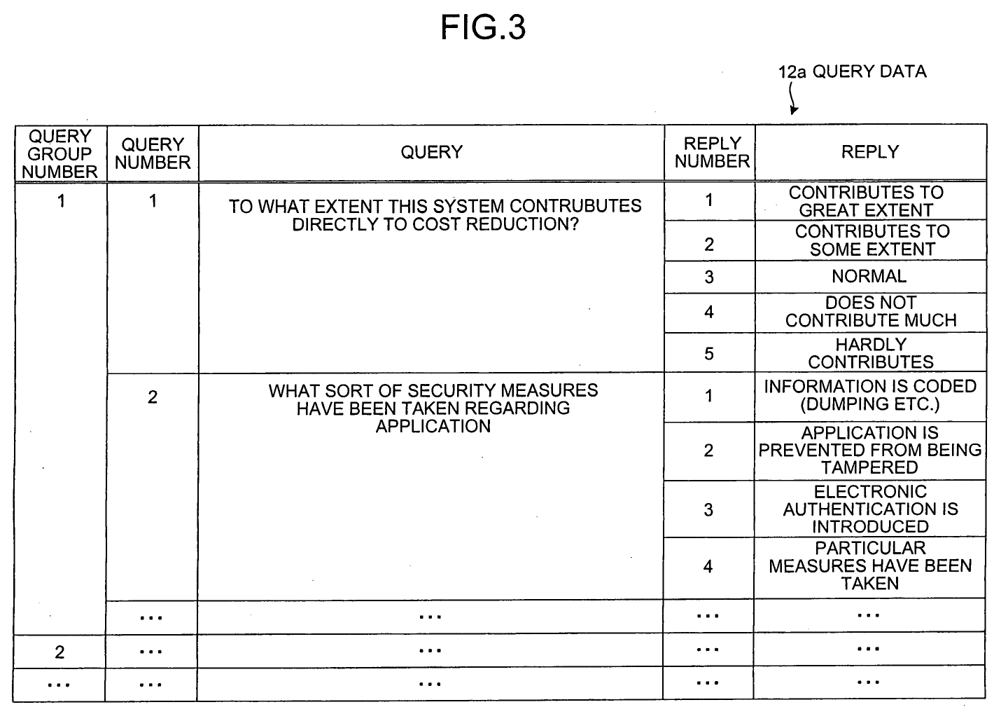

FIG. 3 is a diagram showing an example of the query data 12a shown in FIG. 2. As shown in FIG. 3, this query data 12a stores data of a query group number, a query number, a query, a reply number, and a reply.

The query group number is an identification number that identifies a query group that is made for each investment item. The query group, for example, is a set of queries such as a set of queries for an investment item that is in a planning stage and a set of queries for an investment item related to operation and maintenance of an IT system that is already in operation or a set of queries for an investment item, which is related to optimization of an IT system that is already in operation.

The query number is an identification number that identifies a query that belongs to each query group. The query belongs to each query group and is a question that is made for evaluating the investment item. The reply number is an identification number that identifies a candidate of a reply to each question. The reply is a candidate of a reply to each question.

In the example in FIG. 3, a query corresponding to a query group number “1” and a query number “1” is “to what extent this system contributes directly to cost reduction?” and a reply of a reply number “1” corresponding to this query is “contributes to great extent”. Similarly, in a case of other query numbers as well as reply numbers, a content of the query and a content of the reply are stored.

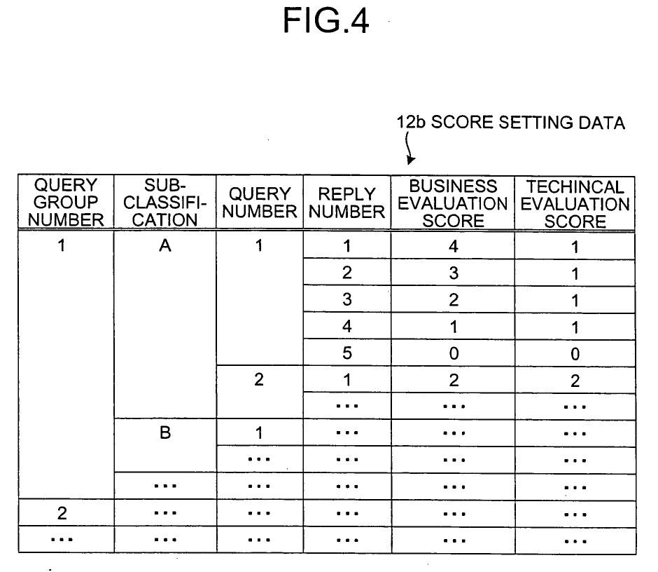

Coming back to a description of FIG. 2, the score setting unit 12b is data in which a score that is set in a reply to a query is stored for evaluating the business contribution and the technical contribution. FIG. 4 is a diagram showing an example of the score setting data 12b shown in FIG. 2.

As shown in FIG. 4, this score setting data 12b is data that includes data of the query group number, a sub-classification, the query number, the reply number, a business evaluation score, and a technical evaluation score. The query group number is a number similar to the query group number shown in FIG. 3 and is an identification number that identifies each query group. The sub-classification is an identification symbol that identifies each group when the queries of each query group are classified into groups.

The query number is similar to the query number shown in FIG. 3 and is an identification number that identifies each query. The reply number is similar to the reply number shown in FIG. 3 and is an identification number that identifies each reply.

The business evaluation score is a score that evaluates the contribution to the business that is assigned to each reply. For example, when the reply conforms to a management strategy the score becomes high and on the other hand when the reply does not conform to the management strategy the score becomes low.

The technical evaluation score is a score that evaluates the technical contribution that is assigned to each reply. For example, when an advanced technology is used and know-how of that technology has been accumulated in-house, the score becomes high and on the other hand in a case of a use of a technology for which a support has been discontinued and a technology, which in spite of being an advanced technology, has not been standardized, the score becomes low.

In the example in FIG. 4, the business evaluation score and the technical evaluation score of a reply of a reply number “1” corresponding to a query of the query group number “1”, a sub-classification “A” and the query number “1” are “4” and “1” respectively. Similarly in a case of other replies, the business evaluation score and the technical evaluation score are assigned.

Coming back to the description of FIG. 2, the weight coefficient data 12c is data in which a weight coefficient by which the score such as the business evaluation score and the technical evaluation score described in FIG. 4 are multiplied. By changing this weight coefficient according to an enterprise or timing, the degree of importance of the reply can be changed according to the enterprise or the timing.

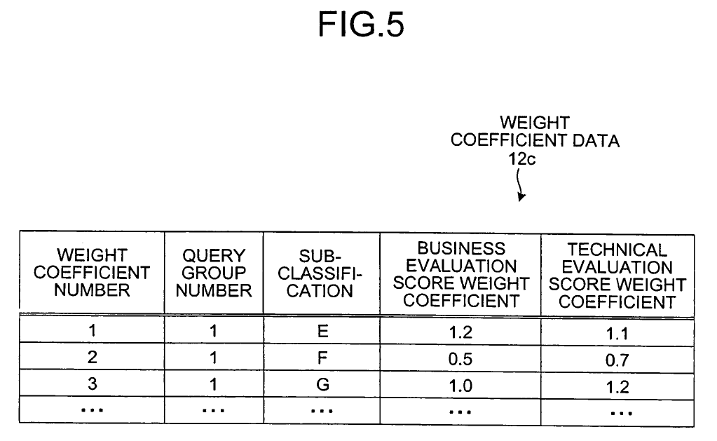

FIG. 5 is a diagram showing an example of the weight coefficient data 12c shown in FIG. 2. As shown in FIG. 5, this weight coefficient data 12c has a weight coefficient number, the query number, the sub-classification, a business evaluation score weight coefficient and a technical evaluation score weight coefficient stored in it.

The weight coefficient number is an identification number that identifies a weight coefficient that is assigned to each reply. The query group number is a number similar to the query group number shown in FIG. 3 and is an identification number that identifies a query group in which the weight coefficient is applied.

The sub-classification is a classification similar to the sub-classification shown in FIG. 3 and is an identification number that identifies a sub-classification in which the weight coefficient is applied. The business evaluation score weight coefficient is a weight coefficient by which the business evaluation score and a sum value of the business evaluation scores are multiplied. The technical evaluation score weight coefficient is a weight coefficient by which the technical evaluation score and a sum value of the technical evaluation scores are multiplied.

In the example in FIG. 5, when the weight coefficient is “1”, the business evaluation score weight coefficient and the technical evaluation score weight coefficient of a reply to a query with the query group number “1” and the sub-classification “E” are “1.2” and “1.1” respectively. Similarly in a case of other weight coefficients, the business evaluation score weight coefficient and the technical evaluation score weight coefficients are assigned.

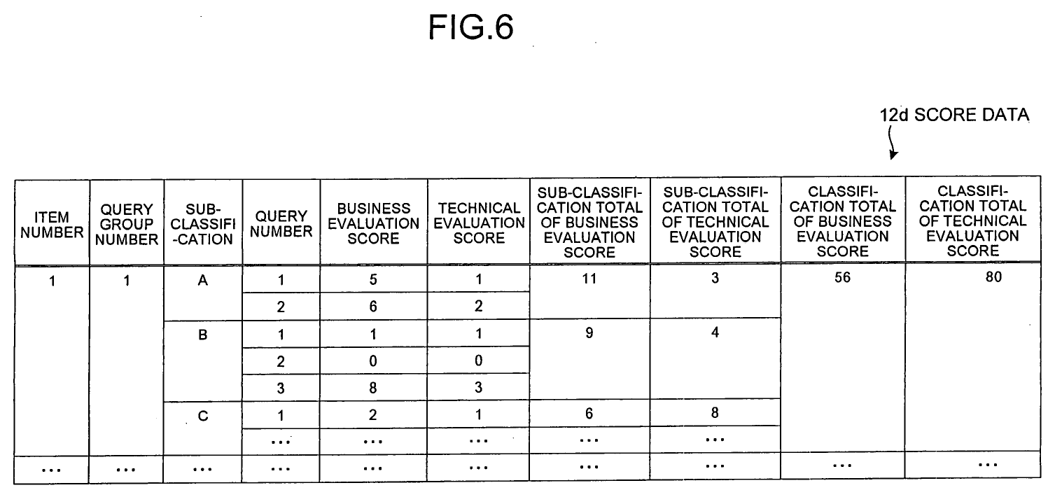

Coming back to the description of FIG. 2, the score data 12d is data in which a score of a reply is stored when a reply is imparted to each query. FIG. 6 is a diagram showing an example of the score data 12d shown in FIG. 2.

As shown in FIG. 6, this score data 12d stores each data of the item number, the query group number, the sub-classification, the query number, the business evaluation score, the technical evaluation score, a sub-classification total of the business evaluation score, a sub-classification total of the technical evaluation score, a classification total of the business evaluation score, and a classification total of the technical evaluation score.

The item number is an identification number that identifies each investment item. The query group number is a number similar to the query group number shown in FIG. 3 and is an identification number that identifies each query group. The sub-classification is similar to the sub-classification shown in FIG. 4 and is an identification symbol that identifies each group when queries in each query group are classified into several groups. The query number is a number similar to the query number shown in FIG. 3 and is an identification number that identifies each query.

The business evaluation score is a score similar to the business evaluation score shown in FIG. 4 and is data in which a business evaluation score corresponding to a reply made to a query is stored. The technical evaluation score is a score similar to the technical evaluation score shown in FIG. 4 and is data in which a technical evaluation score corresponding to a reply made to a query is stored.

The sub-classification total of the business evaluation score is a total in which the business evaluation score is summed up by sub-classification. The sub-classification total of the technical evaluation score is a total in which the technical evaluation score is summed up by sub-classification. The classification total of the business evaluation score is a total in which the business evaluation score is summed up in each query group. The classification total of the technical evaluation score is a total in which the technical evaluation score is summed up in each query group.

The classification total of the business evaluation score and the classification total of the technical evaluation score become X coordinates and Y coordinates respectively of a center of the circles 4₁ to 4₈ that are drawn on the portfolio chart 1. In other words, the classification total of the business evaluation score and the classification total of the technical evaluation score correspond to the X-axis 2 (technical contribution) and the Y-axis 3 (business contribution).

In the example in FIG. 6, it is shown that for an item number “1”, queries for which the query numbers are “1”, “2”, . . . that belong to the query group of the query group number “1” are made and the business evaluation score of replies to those queries is “5”, “6”, . . . and the technical evaluation score of replies to those queries is “1”, “2”, . . . .

Moreover, it is shown that for this item the sub-classification total of the business evaluation score is “11”, “9”, . . . , the sub-classification total of the technical evaluation score is “3”, “4”, . . . , the classification total of the business evaluation score is “56”, and the classification total of the technical evaluation score is “80”.

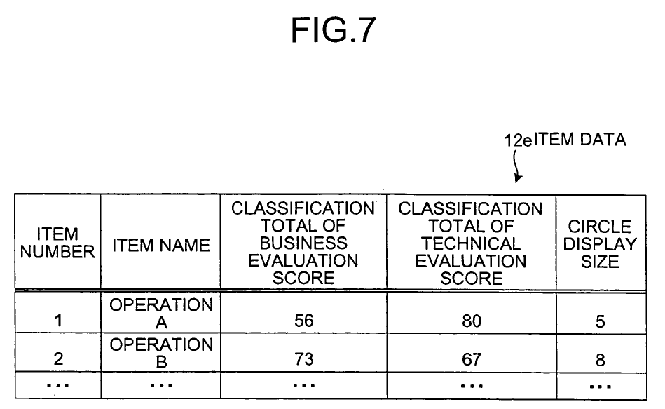

Coming back to the description of FIG. 2, the item data 12e is data in which data related to each investment item is stored. FIG. 7 is a diagram showing an example of the item data 12e shown in FIG. 2. As shown in FIG. 7, this item data 12e is data in which each data of the item number, an item name, the classification total of the business evaluation score, the classification total of the technical evaluation score, and a circle display size is stored.

The item number is a number similar to the item number shown in FIG. 6 and is an identification number that identifies each investment item. The item name is a name given to the investment item. The classification total of the business evaluation score is similar to the classification total of the business evaluation score shown in FIG. 6 and is a total in which the business evaluation score is summed up in each query group. The classification total of the technical evaluation score is similar to the classification total of the technical evaluation score shown in FIG. 6 and is a total in which the technical evaluation score is summed up in each query group.

The circle display size is data in which radii (relative values) of the circles 4₁ to 4₈ when a position of each investment item on the portfolio chart 1 is displayed by the circles 4₁ to 4₈, are stored. The radii of the circles 4₁ to 4₈ are determined according to whether an investment cost is low or high.

In the example in FIG. 7, the item name of an item with the item number “1” is “operation A”, the classification total of the business evaluation score is “56”, the classification total of the technical evaluation score is “8”, and the circle display size is “5”. Similar data is stored in a case of other item.

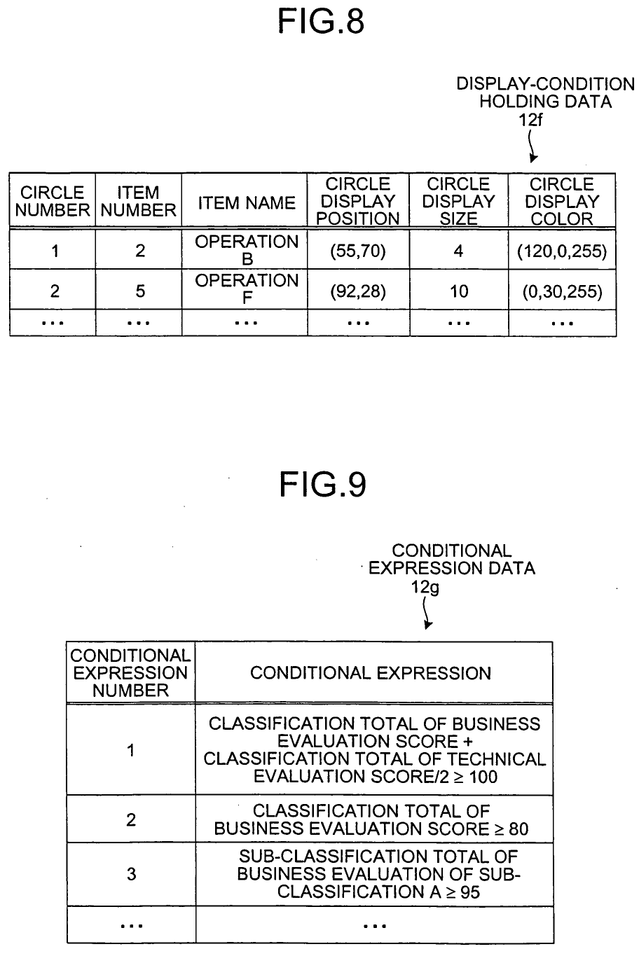

Coming back to the description of FIG. 2, the display condition holding data 12f is data in which a display condition when the position of each investment item on the portfolio chart 1 is displayed by the circles 4₁ to 4₈. FIG. 8 is a diagram showing an example of the display condition holding data 12f shown in FIG. 2.

As shown in FIG. 8, the display condition holding data 12f is data in which each data of a circle number, the item number, the item name, a circle display position, the circle display size, and a circle display color is stored. The circle number is an identification number that identifies each of the circles 4₁ to 4₈ that are displayed. The item number is a number similar to the item number shown in FIG. 6 and is an identification number that identifies each investment item.

The item name is a name similar to the item name shown in FIG. 7 and is a name given to the investment item. The circle display position is data that shows display position of the circles 4₁ to 4₈ on the portfolio chart 1 and has central coordinates (X, Y) of the circles 4₁ to 4₈ stored in it. Here, X is a value of the classification total of the business evaluation score and Y is a value of the classification total of the technical evaluation score.

The circle display size is similar to the circle display size shown in FIG. 7 and is data that shows the radii (relative values) of the circles 4₁ to 4₈ when the position of each investment item on the portfolio chart 1 is displayed by the circles 4₁ to 4₈. The circle display color is data of colors when the circles 4₁ to 4₈ are displayed and is data of colors designated by an RGB format.

In the example in FIG. 8, it is shown that the circles 4₁ to 4₈ with the circle number “1” correspond to an investment item with the item number “2” and the item name “operation B”, and has the circle display position (55, 70), the circle display size “4”, and the circle display color (120, 0, 255). Similar data is stored for the circles 4₁ to 4₈ with other circle numbers.

Coming back to the description of FIG. 2, the conditional expression data 12g is data in which conditional expression that regulates the priority area 5 displayed on the portfolio chart 1 is stored. FIG. 9 is a diagram of an example of the conditional expression data 12g shown in FIG. 2.

As shown in FIG. 9, this conditional expression data 12g stores data of a conditional expression number and a conditional expression. The conditional expression number is an identification number that identifies each conditional expression. The conditional expression is a conditional expression that regulates the priority area 5 displayed on the portfolio chart 1. The user can display the priority area 5 on the portfolio chart 1 by designating a conditional expression that is stored.

In the example in FIG. 9, a conditional expression with the conditional expression number “1”, which is “classification total of business evaluation score+classification total of technical evaluation score/2≧100” is stored. Similarly, for other conditional expression number, a conditional expression that regulates the priority area 5 is stored.

Coming back to the description of FIG. 2, the query executing unit 13 reads the query data 12a from the storage unit 12 and performs a process of outputting a query for each investment item to the display unit 11. Then, the query executing unit 13 receives that reply from the user and detects the business evaluation score and the technical evaluation score corresponding to the reply from the score setting data 12b.

Moreover, the query executing unit 13 reads the weight coefficient data 12c, multiplies the business evaluation score and the technical evaluation score by the weight coefficient, and stores the business evaluation score and the technical evaluation score obtained from that result as the score data 12d.

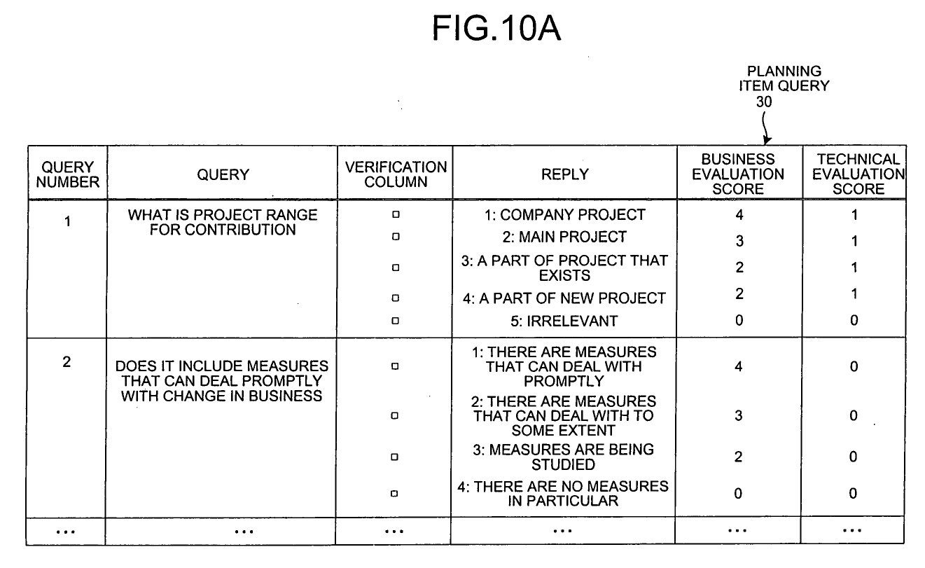

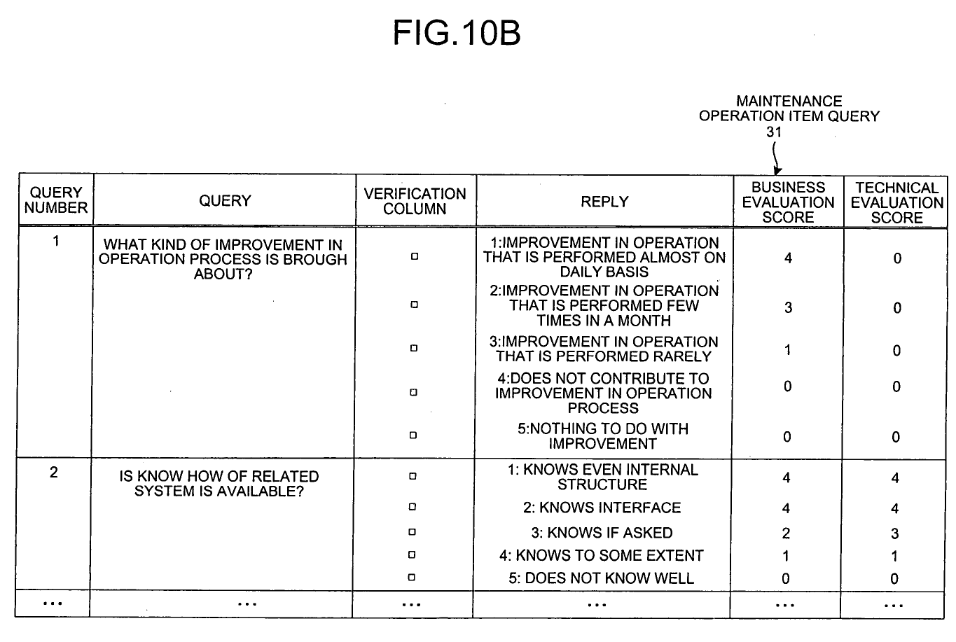

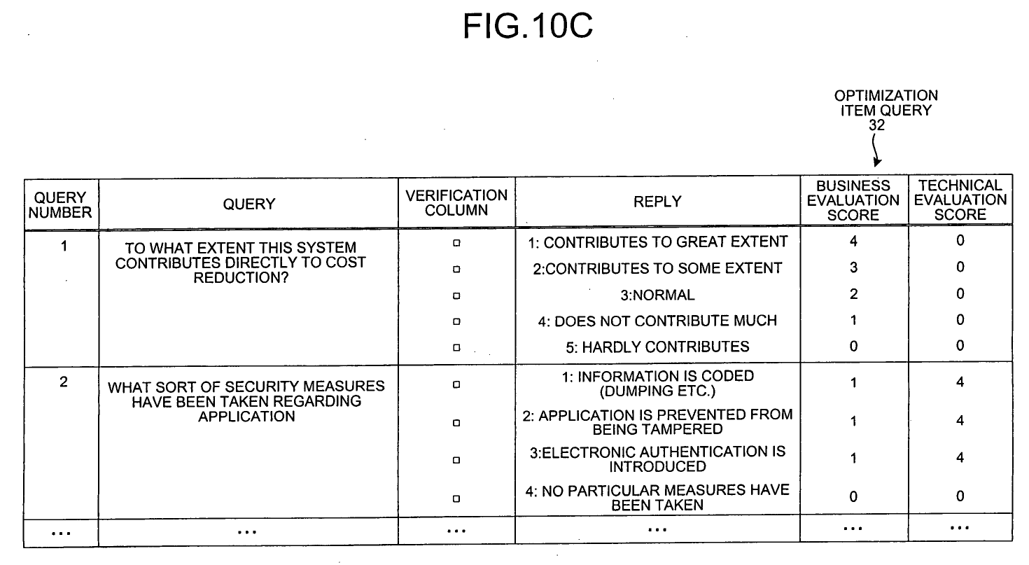

FIG. 10-1, FIG. 10-2, and FIG. 10-3 are diagrams showing an example of an output of a query that is output to the display unit 11. FIG. 10-1 shows a planning item query 30 that is a query for an investment item, which is in a planning stage, FIG. 10-2 shows an operation and maintenance item query 31 that is a query for an investment item related to the operation and maintenance of the IT system, which is already in operation, and FIG. 10-3 shows an optimization item query 32 that is a query for an investment item, which is related to an optimization of the IT system that is already in operation.

In the example of output of the planning item query 30, the operation and maintenance item query 31, and the optimization item query 32, each of items viz. the query number, the query, a verification column, the reply, the business evaluation score, and the technical evaluation score is output.

The query number is a number similar to the query number described in FIG. 3 and is an identification number that identifies each query. The query is similar to the query described in FIG. 3 and is a query for each investment item. The verification column is a verification column in which a selection of a reply of each query is received from the user by an operation of a mouse etc.

The reply is similar to the reply described in FIG. 3 and is a candidate of a reply to the query. The business evaluation score and the technical evaluation score are similar to the business evaluation score and the technical evaluation score described in FIG. 4 and are scores that evaluate the technical contribution and the contribution of the business that is assigned to each reply.

Coming back to the description of FIG. 2, the score summing unit 14 sums up the business evaluation score and the technical evaluation score of each reply that is stored by the query executing unit 13, then calculates the sub-classification total of the business evaluation score, the sub-classification total of the technical evaluation score, the classification total of the business evaluation score, and the classification total of the technical evaluation score, and performs the process of storing in the score data 12d.

The chart creating unit 15 creates the portfolio chart 1 in which the business contribution and the technical contribution of each investment item is shown by the display position of the circles 4₁ to 4₈, by referring to the score data 12, and outputs to the display unit 11.

Concretely, the chart creating unit 15 creates the portfolio chart 1 in which the circles 4₁ to 4₈ that have radii, which are set based on the investment cost, by letting the classification total of the business evaluation score and the classification total of the technical evaluation score to be the central X coordinates and Y coordinates.

The priority-area display processing unit 16 refers to the conditional equation data 12g and performs a process of displaying the priority area 5 on the portfolio chart 1. The circle display form changing unit 17 changes a display form of the circles 4₁ to 4₈ that are displayed on the portfolio chart 1.

Concretely, the circle display form changing unit 17 makes a color display of the circles 4₁ to 4₈ for which the central position is included in the priority area 5 or an inside of the circles 4₁ to 4₈ that are designated by the user, then lets an inside of other circles 4₁ to 4₈ to be transparent or semitransparent (skeleton display), and displays so that the user can verify easily the target circles 4₁ to 4₈.

The circle display form changing unit 17 changes a display color of the circles 4₁ to 4₈ for which the central position is included in the priority area 5 or the circles 4₁ to 4₈ that are designated by the user to a display color that is different from the display color of other circles 4₁ to 4₈ and displays so that the user can verify easily the target circles 4₁ to 4₈.

In a case of making the inside of the other circles 4₁ to 4₈ to be transparent or semitransparent (skeleton display), in a case of changing the display color of the circles 4₁ to 4₈ to a different display color, or in a case of the specific circles 4₁ to 4₈ to be non-displayed by the circle non-display processing unit 18, the circle display form changing unit 17 stores a display condition of the circles 4₁ to 4₈ before changing in the display condition holding data 12f.

Then, when a predetermined button is clicked by using the mouse etc. by the user and a request is made to return to the display condition of the circles 4₁ to 4₈ before changing the display condition or when a request is made to terminate designation of the priority area 5, the circle display form changing unit 17 performs a process of returning to the display condition before changing.

The circle non-display processing unit 18 displays only the circles 4₁ to 4₈ for which the central coordinates are included in the priority area or the circles 4₁ to 4₈ that are designated by the user lets the other circles 4₁ to 4₈ to be non-display so that the user can verify easily the target circles 4₁ to 4₈.

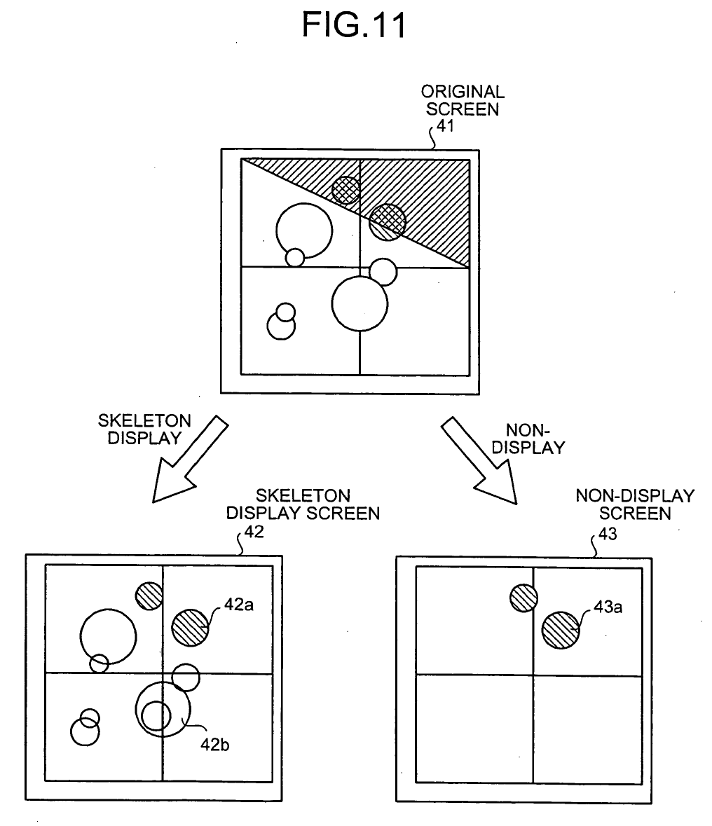

FIG. 11 is a diagram illustrating a skeleton display process and a non-display process that are mentioned above. In FIG. 11, a skeleton display screen 42 in which a skeleton display of a circle 42b other than a circle 42a in which the central position is included in the priority area is made and a non-display screen 43 in which a circle other than a circle 43a in which the central position is included in the priority area is let to be non-display are shown from an original screen 4₁ in which a circle and the priority area corresponding to a plurality of investment items are displayed.

Coming back to the description of FIG. 2, the trajectory estimating unit 19 performs a process of estimating a transition in evaluation of an investment item of a time series such as a planning of introduction of an IT system, an operation and maintenance after introduction of the IT system, and an optimization of the IT system after that.

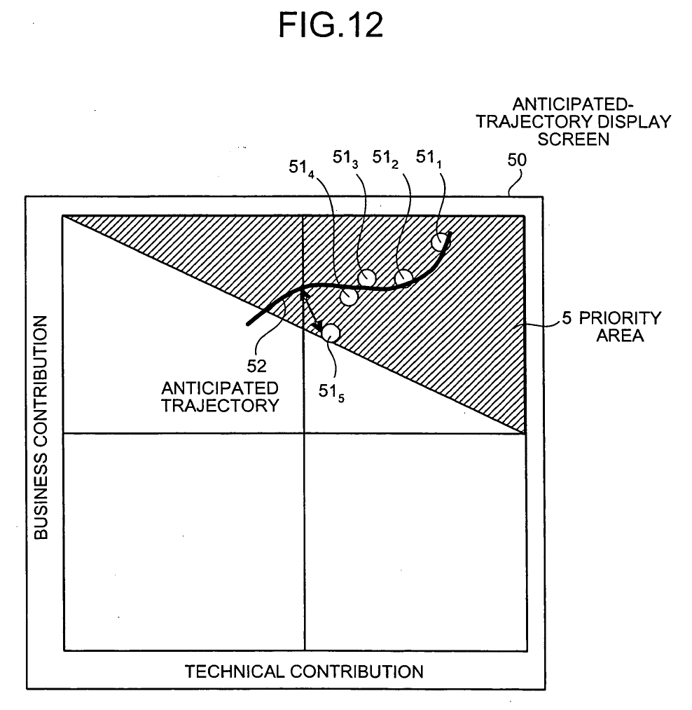

FIG. 12 is a diagram showing a trajectory estimation process mentioned above. In FIG. 12, an anticipated-trajectory display screen 50 in which an anticipated trajectory 52 that shows a future transition of the evaluation of the investment item, is displayed. Here, circles 51₁ to 51₅ show actual transition of evaluation of an investment in various life cycles of an IT system such as a planning, operation and maintenance after introduction, and a point of time of optimization of a certain IT system.

The trajectory estimating unit 19 receives from the user a selection of an investment item of a time series that estimates the anticipated trajectory 52, from the investment items that are stored in the item data 12e, and creates the anticipated-trajectory display screen 50. Concretely, the trajectory estimating unit 19 determines positions of circles 51₁ to 51₅ by letting the classification total of the business evaluation score and the classification total of the technical evaluation score of the investment item that is selected, to be the X-coordinates and Y-coordinates which are the central coordinates.

Then, the trajectory estimating unit 19 performs a process of creating the anticipated trajectory 52 that anticipates a future coordinate position of the circles 51₁ to 51₅, which change according to the life cycle of the investment item by using a polynomial approximation or an exponential approximation of the central coordinates of the circles 51₁ to 51₅ and displaying the anticipated trajectory 52 that is created.

Coming back to the description of FIG. 2, when a position of the circles 51₁ to 51₅ that is displayed based on the evaluation of the actual investment item is diverged by a distance that is not less than a predetermined value from the anticipated trajectory 52 that is estimated by the trajectory estimating unit 19, the trajectory divergence detecting unit 20 performs a process of detecting it and outputting a warning message.

If the position of the circles 51₁ to 51₅ is diverged by a value not less than the predetermined value from the anticipated trajectory 52, since some unexpected situation can be considered to have occurred, such kind of a warning message is output. In FIG. 12, a case in which the circle 51₅ is diverged from the anticipated trajectory 52 by a distance not less than the predetermined distance is shown.

The priority area deviation detecting unit 21 performs a process of estimating a timing at which the anticipated trajectory 52 that is estimated by the trajectory estimating unit 19 is deviated from the priority area 5. Concretely, the priority area deviation detecting unit 21 finds an interunit of a boundary of the anticipated trajectory 52 and the priority area 5, and calculates an average value of a traveling speed at which the circles 51₁ to 51₅ move along the anticipated trajectory 52.

Then, the priority area deviation detecting unit 21 estimates a distance that is measured along the anticipated trajectory 52 between the interunit and the current position of the circles 51₁ to 51₅ and a timing at which the anticipated trajectory 52 deviates from the priority area 5, from the average value of the traveling speed.

Moreover, if the central position of the circles 51₁ to 51₅ that are displayed based on an evaluation of the actual investment item is deviated from the priority area 5, the priority area deviation detecting unit 21 performs a process of detecting that, and outputting a warning message.

The item list output unit 22 performs a process of outputting an average value of each investment items that is displayed in the portfolio chart 1 as an item list for each quadrant of the portfolio chart 1, to the display unit 11 or an external unit (not shown in the diagram) such as a printer.

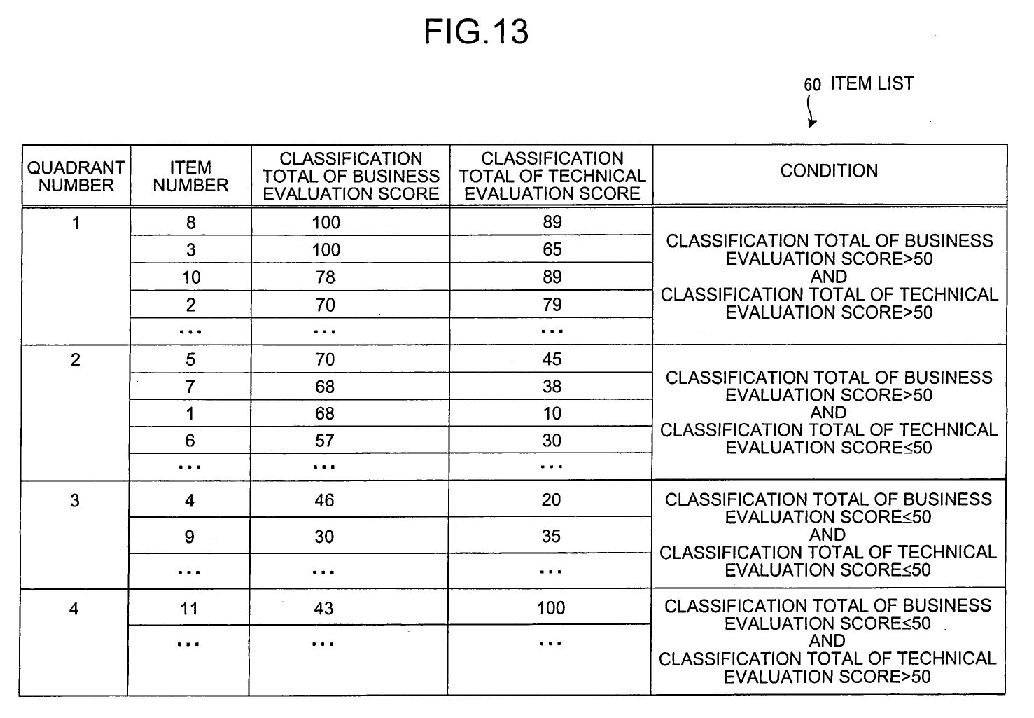

FIG. 13 is a diagram showing an example of the item list 60 mentioned above. As shown in FIG. 13, in this item list 60, a quadrant number, the item number, the classification total of the business evaluation score, the classification total of the technical evaluation score, and each data of a condition is output.

The quadrant number is an identification number that identifies each quadrant of the portfolio chart 1. The item number is a number similar to the item number shown in FIG. 6 and is an identification number that identifies each item. The classification total of the business evaluation score is similar to the classification total of the business evaluation score shown in FIG. 6 and is a score in which the business evaluation score is summed up in each query group. The classification total of the technical evaluation score is similar to the classification total of the technical evaluation score shown in FIG. 6 and is a score in which the technical evaluation score is summed up in each query group. The condition is a condition that regulates an area of each quadrant in the portfolio chart 1.

Coming back to the description of FIG. 2, the controlling unit 23 is a controlling unit that performs overall control of the evaluation result output unit. This controlling unit 23 controls transfer of data between functioning units mentioned above.

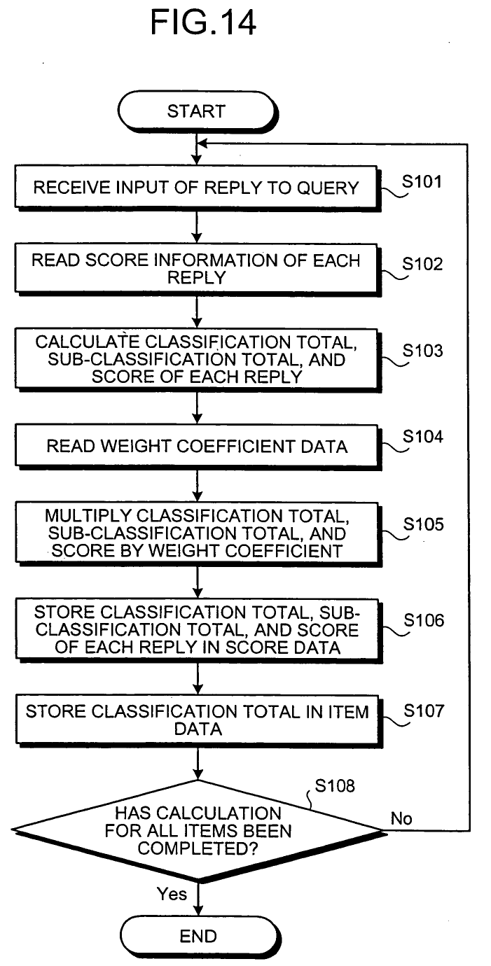

FIG. 14 is a flow chart of the processing procedure of a calculation process that calculates score of each item. As shown in FIG. 14, to start with, the query executing unit 13 of the evaluation result output unit receives an input of a reply to a query from the user (step S101) and reads score information of the reply from the score setting data 12b (step S102).

Then, the query executing unit 13 calculates the business evaluation score and the technical evaluation score of each reply and the score summing unit 14 calculates the sub-classification total of the business evaluation score, the sub-classification total of the technical evaluation score, the classification total of the business evaluation score, and the classification total of the technical evaluation score, respectively (step S103).

Subsequently, the query executing unit 13 and the score summing unit 14 read the weight coefficient data 12c (step S104), the query executing unit 13 multiplies the business evaluation score and the technical evaluation score of each reply by the weight coefficient, the score summing unit 14 multiplies the sub-classification total of the business evaluation score, the sub-classification total of the technical evaluation score, the classification total of the business evaluation score, and the classification total of the technical evaluation score by the weight coefficient (step S105).

Then, the query executing unit 13 stores the business evaluation score and the technical evaluation score that are multiplied by the weight coefficient, in the score data 12d and the score summing unit 14 stores the sub-classification total of the business evaluation score, the sub-classification total of the technical evaluation score, the classification total of the business evaluation score, and the classification total of the technical evaluation score multiplied by the weight coefficient, in the score data 12d (step S106).

After this, further the score summing unit 14 stores the classification total of the business evaluation score and the classification total of the technical evaluation score in the item data 12e (step S107). Then, the query executing unit 13 checks whether calculation of all items is completed or not (step S108).

If the calculation of all items is not completed (No at step S108), the process returns to step S101, and the process from step S101 onward, is continued. If the calculation of all items is completed (Yes at step S108), the calculation process is terminated as it is.

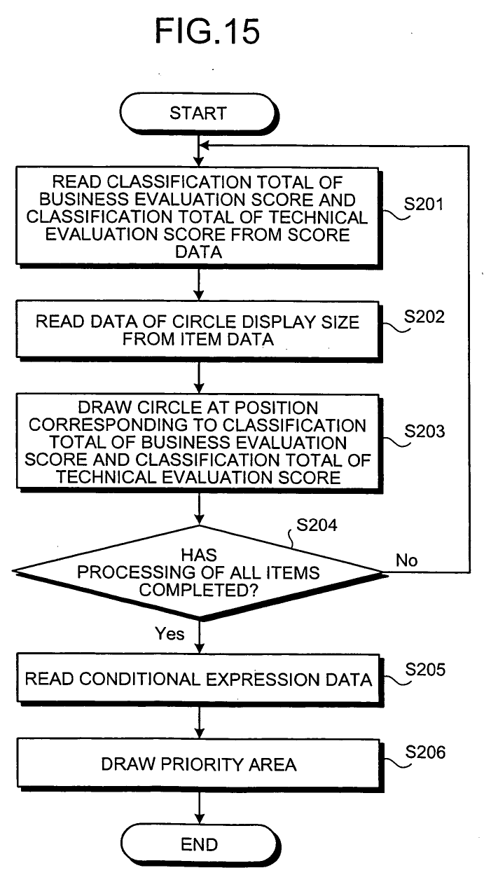

FIG. 15 is a flow chart of the processing procedure of the drawing process for drawing the portfolio chart 1.

As shown in FIG. 15, to start with, the chart creating unit 15 of the evaluation result output unit reads information of the classification total of the business evaluation score and the classification total of the technical evaluation score from the score data 12d (step S201).

Then, the chart creating unit 15 reads data of the circle display size from the item data 12e (step S202). Subsequently, the chart creating unit draws the circles 4₁ to 4₈ at a position corresponding to the classification total of the business evaluation score and the classification total of the technical evaluation score, by the circle display size that is read (step S203).

After this, the chart creating unit 15 checks whether the processing of all items is completed or not (step S204), if not completed (No at step S204), the process returns to step S201 and the process from the step S201 onward is continued.

If the processing of all items is completed (Yes at step S204), the priority area display processing unit 16 reads the conditional expression data 12g (step S205). Then, the priority area display processing unit 16 draws the priority area 5 on the portfolio chart 1 based on a conditional expression that is included in the conditional expression data 12g and designated by the user and terminates the drawing process (step S206).

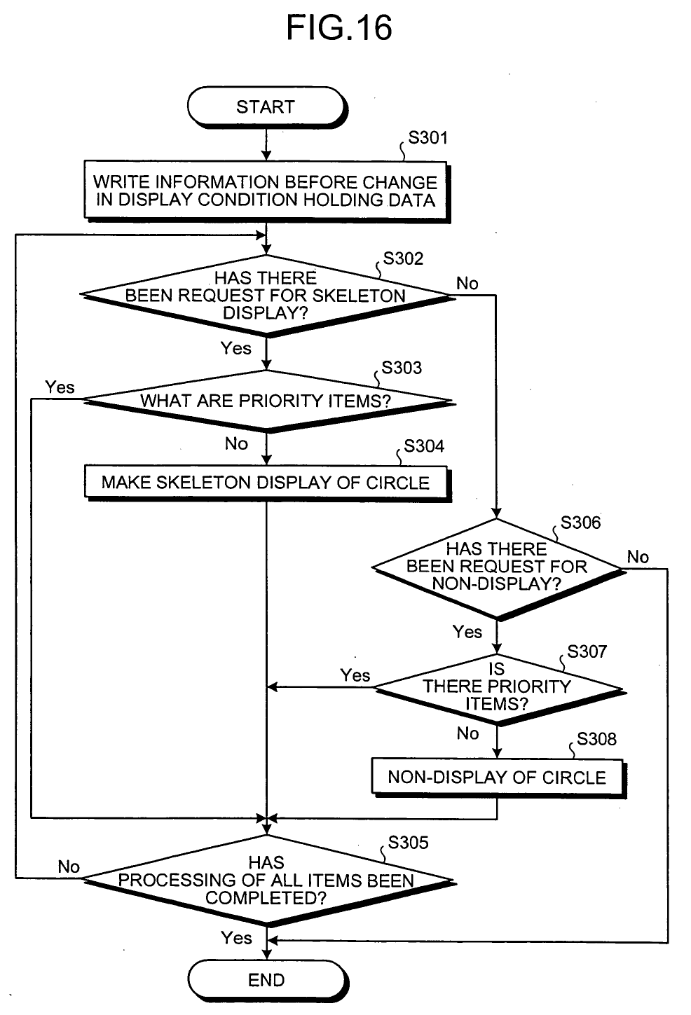

FIG. 16 is a flow chart showing a processing procedure of the skeleton display process or a non-display process of the circles 4₁ to 4₈.

As shown in FIG. 16, to start with, the circle display form changing unit 17 of the evaluation result output unit writes information of a display form before changing the display form of the circles 4₁ to 4₈ in the display condition holding data 12f (step S301).

Then, the circle display form changing unit 17 checks whether a request that is received from the user is a skeleton display request of the circle 4₁ to 4₈ or not (step S302). If the request is a skeleton display request of the circles 4₁ to 4₈ (Yes at step S302), the circle display form changing unit 17 checks whether or not the circles 4₁ to 4₈ that are drawn on the portfolio chart 1 are circles that correspond to the priority condition for which the center is in the priority area (step S303).

If the circles 4₁ to 4₈ are not the circles that correspond to the priority condition for which the center is in the priority area (No at step S303), the circle display form changing unit 17 performs a skeleton display of those circles 4₁ to 4₈ (step S304), and a process of checking whether the processing of all the items is completed or not (step S305).

Then, if the processing of all the items is not completed (No at step S305), the process returns to step S302 and the process from step S302 is continued. If the processing of all the items is completed (Yes at step S305), the process is terminated as it is.

At step S303, if the circles 4₁ to 4₈ are circles that correspond to the priority item for which the center is in the priority area 5 (Yes at step S303), the process returns as it is, to step S305 and the process from the step S305 onward is continued.

At step S302, if the request received from the user is not a skeleton display request of the circles 4₁ to 4₈ (No at step S302), the circle non-display processing unit 18 checks whether or not the request received from the user is a non-display request of the circles 4₁ to 4₈ (step S306).

Then, if the request is a non-display request of the circles 4₁ to 4₈ (Yes at step S306), the circle non-display processing unit 18 checks whether the circles 4₁ to 4₈ drawn in the portfolio chart 1 are circles that correspond to the priority item for which the center is in the priority area 5 or not (step S307).

If the circles 4₁ to 4₈ are not the circles corresponding to the priority item for which the center is in the priority area 5 (No at step S307), the circle non-display processing unit 18 lets those circles 4₁ to 4₈ to be non-display (step S308), the process returns to step S305, and the process from step S305 onward is continued.

At step S307, if the circles 4₁ to 4₈ are circles corresponding to the priority item for which the center is in the priority area 5 (Yes at step S307), the process returns to step S305 and the process from the step S305 onward is continued. Moreover, at step S306, if the request received from the user is not a non-display request of the circles 4₁ to 4₈ (No at step S306), the process is terminated as it is.

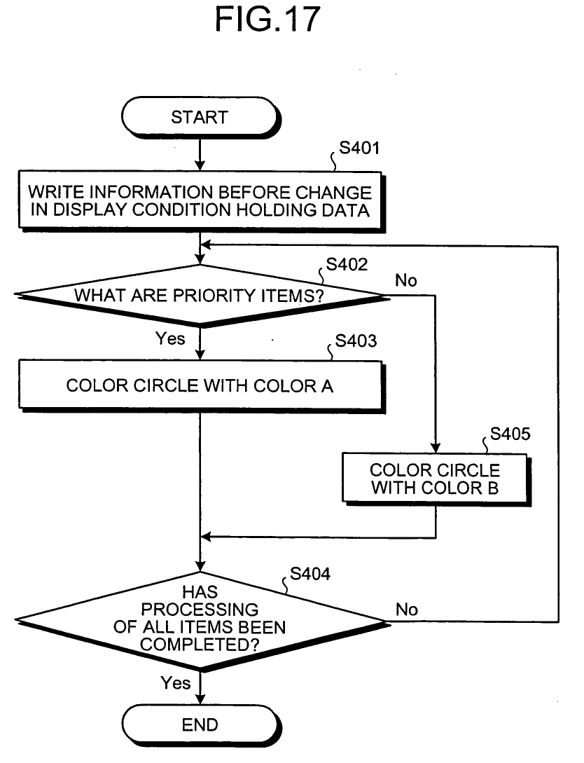

FIG. 17 is a flow chart showing a processing procedure of the coloring process of the circles 4₁ to 4₈.

As shown in FIG. 17, to start with, the circle display form changing unit 17 of the evaluation result output unit writes information of a display form before changing the display form of the circles 4₁ to 4₈ in the display condition holding data 12f (step S401).

Then, the circle display form changing unit 17 checks whether the circles 4₁ to 4₈ drawn in the portfolio chart 1 are circles that correspond to the priority item for which the center is in the priority area 5, or not (step S402).

If the circles 4₁ to 4₈ are circles that correspond to the priority item for which the center is in the priority area 5 (Yes at step S402), the circle display form changing unit 17 colors an inside of the circles 4₁ to 4₈ by a predetermined color (color A) (step S403) and performs a process of checking whether the processing of all items is completed or not (step S404).

Then, if the processing of all items is not completed (No at step S404), the process returns to step S402 and the process from the step S402 onward is continued. If the processing of all items is completed (Yes at step S404), the process is terminated as it is.

At step S402, if the circles 4₁ to 4₈ are not the circles that correspond to the priority item for which the center is in the priority area (No at step S402), the circle display form changing unit 17 colors the inside of the circles 4₁ to 4₈ by a color (color B) that is different from the color A (step S405), the process returns to step S404, and the process from the step S404 onward is continued.

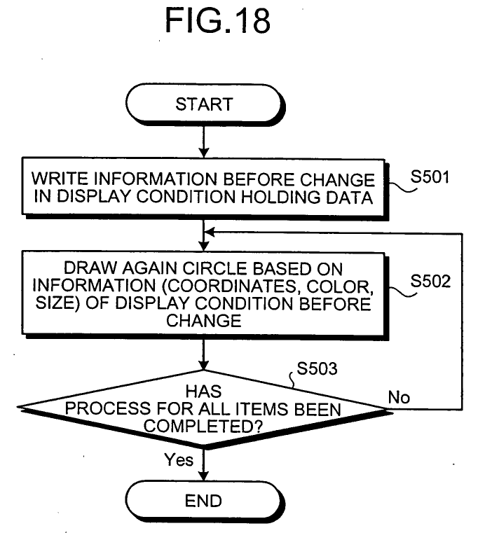

Next, a processing procedure of a display-condition returning process of the circles 4₁ to 4₈ for returning the display condition of the circles 4₁ to 4₈ to an original condition when the circles 4₁ to 4₈ are subjected to the skeleton display process, the non-display process, or the coloring process. FIG. 18 is a flow chart showing a processing procedure of the display-condition returning process of the circles 4₁ to 4₈.

As shown in FIG. 18, to start with, the circle display form changing unit 17 of the evaluation result output unit reads information of the display form before changing the display form of the circles 4₁ to 4₈, from the display condition holding data 12f (step S501). Then the circle display form changing unit 17 performs a process of redrawing the circles 4₁ to 4₈ based on the display condition (coordinates, color, and size) before changing (step S502).

After this, the circle display form changing unit 17 checks whether the processing of all items is completed or not (step S503), if the processing of all items is not completed (No at step S503), the process returns to step S502 and the process from the step S502 onward is continued. If the processing of all the items is completed (Yes at step S503), this process is terminated as it is.

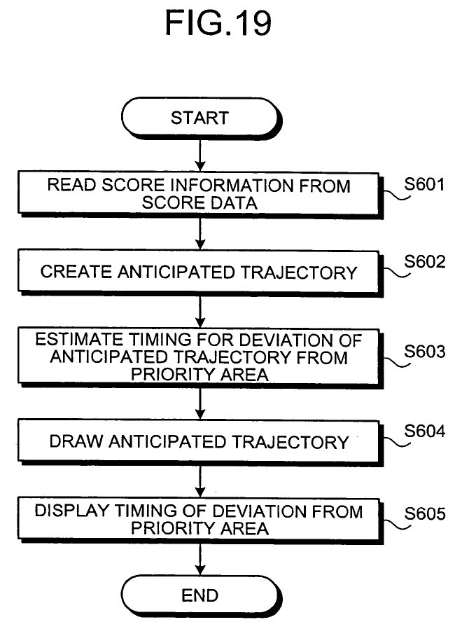

FIG. 19 is a flow chart showing the processing procedure of an anticipated trajectory drawing process. As shown in FIG. 19, to start with, the trajectory estimating unit 19 of the evaluation result output unit reads information of the classification total of the business evaluation score and the classification total of the technical evaluation score of an investment item for which an anticipated trajectory is drawn, from the score data 12d (step S601).

Then, the trajectory estimating unit 19 creates the anticipated trajectory 52 (step S602) by using the polynomial approximation or the exponential approximation of the classification total of the business evaluation score and the classification total of the technical evaluation score which are the X-coordinate and the Y-coordinate of a center of the circles 51₁ to 51₅, and the priority area deviation detecting unit 21 estimates a timing (step 603) at which the anticipated trajectory 52 deviates from the priority area 5.

After this, the trajectory estimating unit 19 draws the anticipated trajectory 52 on the portfolio chart 1 (step S604), the priority area deviation detecting unit 21 displays the timing at which the anticipated trajectory 52 deviates from the priority area 5 (step S605), and terminates the drawing process of the anticipated trajectory 52.

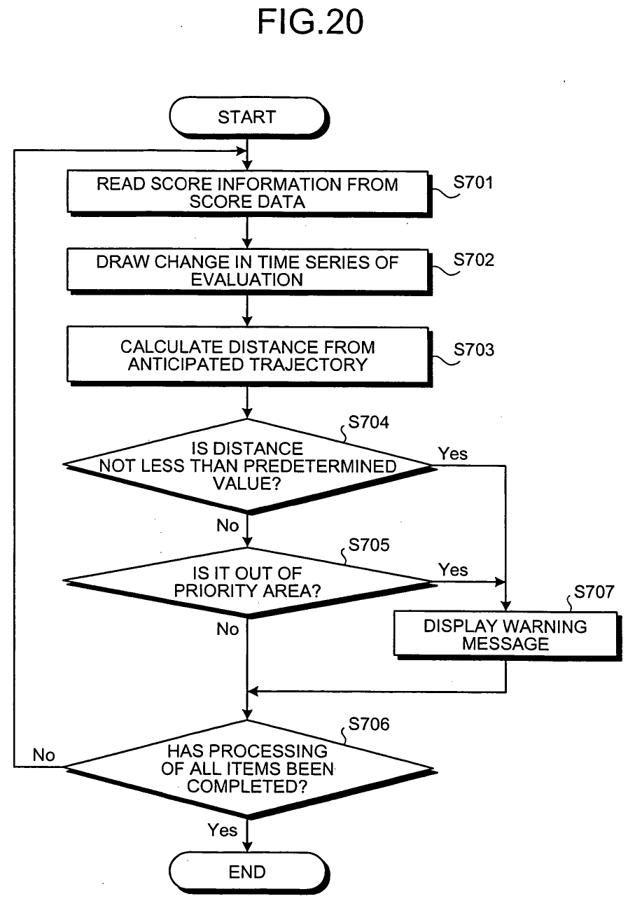

FIG. 20 is a flow chart showing the processing procedure for the warning process based on the anticipated trajectory 52. As shown in FIG. 20, to start with, the trajectory divergence detecting unit 20 of the evaluation result output unit reads information of the classification total of the business evaluations score and the classification total of the technical evaluation score of the investment item from the score data 12d (step S701).

Then, the trajectory divergence detecting unit 20, as shown by the circles 51₁ to 51₅ in FIG. 12, draws the change in the time series of the evaluation of the investment item (step S702 and calculates a distance from the anticipated trajectory 52 (step S703).

Subsequently, the trajectory divergence detecting unit 20 checks whether the distance between the circles 51₁ to 51₅ and the anticipated trajectory is not less than a predetermined value or is less than the predetermined value (step S704), if it is not less than the predetermined value (Yes at step S704), a warning message is displayed on the display unit 11 (step S705).

After this, the trajectory divergence detecting unit 29 checks whether the processing of all items is completed or not (step S706), if the processing of all items is not completed (No at step S706), the process returns to step S701 and the process from step S701 onward is continued. If the processing of all items is completed (Yes at step S706), the process is terminated as it is.

At step S704, if the distance between the circles 51₁ to 51₅ and the anticipated trajectory 52 is less than the predetermined value (No at step S704), the priority area deviation detecting unit 21 checks whether the center of the circles 51₁ to 51₅ is deviated or not from the priority area 5 (step S705).

If the center of the circles 51₁ to 51₅ is deviated from the priority area 5 (Yes at step S705), the priority area deviation detecting unit 21 displays the warning message on the display unit 11 (step S707), then the process returns to step S706 and the process from step S706 onward is continued. If the center of the circles 51₁ to 51₅ is not deviated from the priority area 5 (No at step S705), the process returns as it is to step S706, and the process from step S706 onward is continued.

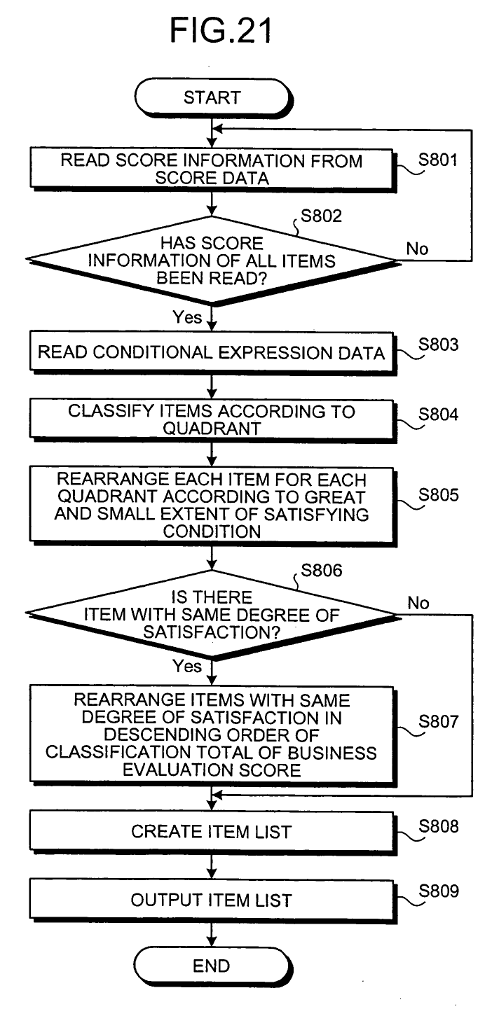

FIG. 21 is a flow chart showing the processing procedure for the output process of the item list 60. As shown in FIG. 21, to start with, the item list output unit 22 of the evaluation result output unit reads information of the item number, the classification total of the business evaluation score, and the classification total of the technical evaluation score, from the score data 12 (step S801).

Then, the item list output unit 22 checks whether score information of all the investment items is read or not (step S802), and if the score information of all the investment items is not read (No at step S802), the process returns to step S801, and reads the score information.

If reading of the score information of all the investment items is completed (Yes at step S802), the item list output unit 22 reads data of a conditional expression that is designated by the user in advance from the conditional expression data 12g (step S803).

Then, the item list output unit 22 classifies the investment items for each quadrant of the portfolio chart 1 (step S804), and performs a process of rearranging the investment items in a descending order of a degree of satisfaction of the conditional expression for each quadrant (step S805).

For example, if the conditional expression is “classification total of business evaluation score+classification total of technical evaluation score/2≧100”, the item list output unit 22 rearranges each investment item in a descending order of a value of “classification total of business evaluation score+classification total of technical evaluation score/2”. Thus, if the conditional expression is in the form “(expression)>(threshold value)” or “(expression)≧(threshold value), a conditional expression for which the value of (expression) is big is judged to be a conditional expression with a high degree of satisfaction.

After this, the item list output unit 22 checks whether there is an investment item with the same degree of satisfaction or not (step S806). For example, if the conditional expression is “classification total of business evaluation score+classification total of technical evaluation score/2≧100”, the item list output unit 22 checks whether there is an investment item with the same value of “classification total of business evaluation score+classification total of technical evaluation score/2” or not.

Then, if there is an investment item with the same degree of satisfaction (Yes at step S806), the item list output unit 22 performs a process of rearranging the investment item with the same degree of satisfaction in the descending order of the value of the classification total of the business evaluation score (step S807).

Subsequently, the item list output unit 22 creates the item list 60 as shown in FIG. 13 (step S808), then outputs the item list 60 that is created to an external unit such as the display unit 11 or a printer (step S809), and terminates the output process of this item list 60. At step S806, if there is not investment item with the same degree of satisfaction (No at step S806), the process returns as it is to step S808 and the process from the step S808 onward is continued.

Incidentally, the evaluation result output unit and a method of evaluation result output that is described in the abovementioned embodiment can be realized by running a program that is prepared, in advance in a computer system such as a personal computer and a work station. A computer system that executes a computer program to output evaluation result, which has functions similar to those of the evaluation result output unit (a method of evaluation result output) that is mentioned above is described below.

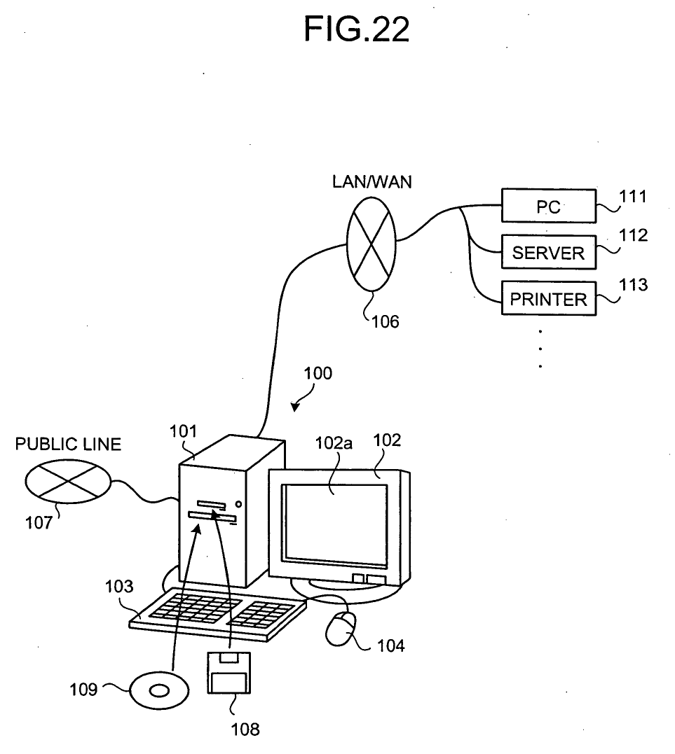

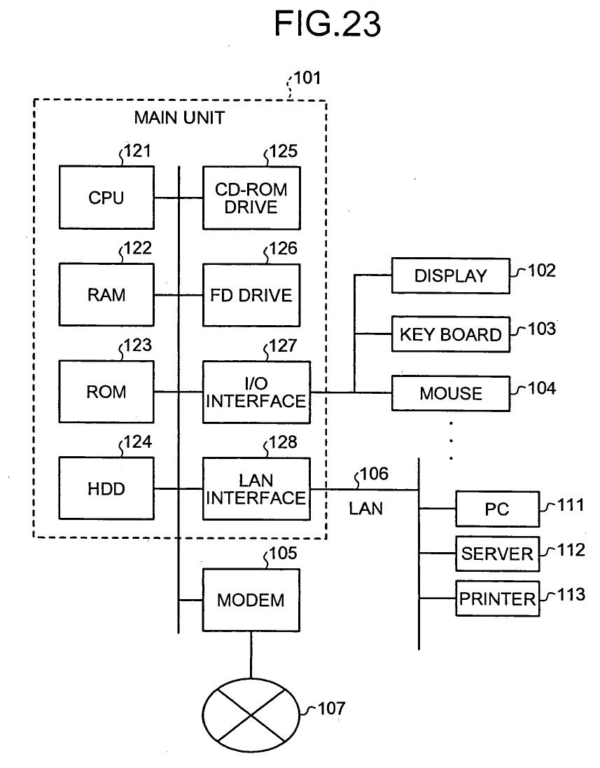

FIG. 22 is a system configuration diagram showing a configuration of a computer system 100 that executes the evaluation result output process, and FIG. 23 is a block diagram showing a configuration of a main body unit 101 in the computer system 100 shown in FIG. 22.

As shown in FIG. 22, this computer system 100 is provided with the main body unit 101, a display 102 for displaying information of image etc. on a display screen 102a according to instructions from the main body unit 101, a key board 103 for inputting various information to the computer system 100, and a mouse 104 for designating a voluntary position on the display screen 102a.

Moreover, the main body unit 101 in this computer system 100, as shown in FIG. 23, is provided with a CPU 121, RAM 122, a ROM 23, a hard disc drive (HDD) 124, a CD-ROM drive 125 that takes in a CD-ROM 109, an FD drive 126 that takes in a flexible disc (FD) 108, an I/O interface 127 to which the display 102, the key board 103, and the mouse 104 are connected, and a LAN interface 128 that is connected to a local area network or a wide area network (LAN/WAN) 106.

Furthermore, a modem 105 for connecting a public line 107 such as the Internet is connected to the computer system 100, and other computer system (PC) 111, a server 112, and a printer 113 etc. are connected to the computer via the LAN interface 128 and the LAN/WAN 106.

The computer system 100 realizes the evaluation result output unit (method of evaluation result output) by executing the computer program to output evaluation result that is recorded in a predetermined recording medium.

Here, the predetermined recording medium includes apart from a portable physical medium such as the flexible disk (FD) 108, the CD-ROM 109, an MO disc, a DVD disc, a magneto-optical disc, and an IC card, all recording media that records the computer program to output evaluation result that is readable by the computer system, such as a fixed physical medium like the hard disc drive (HDD) 124, the RAM 122, and the ROM 123, a communication medium that hold a program for a short time while transmitting the program such as the public line 107 that is connected via the modem 105 and the LAN/VAN to which the other computer system 111 and the server 112 are connected.

In other words, the computer program to output evaluation result is a computer readable program that is recorded in the recording medium such as “the portable physical medium”, “the fixed physical medium, and “the communication medium” and the computer system 100 realizes the evaluation result output unit and the method of the evaluation result output by executing upon reading the computer program to output evaluation result form such a recording medium.

Further, the computer program to output evaluation result is not restricted to be run by the computer system 100, and the present invention can by applied similarly in a case of running the computer program to output evaluation result by the other computer 111 or the server 112, and in a case of running the computer program to output the evaluation result by the other computer 11 and the server 112 in cooperation with each other.

As mentioned above, according to the present embodiment, since the storage unit 12 is let to store the setting conditions of the priority area that indicates the investment item to be prioritized on the portfolio chart 1 as the conditional data 12g and based on the setting condition that is stored, the chart creating unit 15 and the priority area display processing unit 16 are let to output the priority area and the position of coordinates of the investment item in the portfolio chart 1, by outputting the priority area 5 that indicates the investment item that is to be regarded as important and not just showing the position of coordinates of the investment item, the investment item that is to be regarded as important is let to be easily understandable, thereby supporting strongly a decision making performed by the user.

Furthermore, according to the present embodiment, since the circle display form changing unit 17 is let to change the output format such that the output format of the circles 4₁ to 4₈ of the investment item that is indicated by the priority area 5 that is output, or the output format of the circles 4₁ to 4₈ of the investment item that is designated by the user differs from the output format of the circles 4₁ to 4₈ of the other investment items, by letting the output format of the circles 4₁ to 4₈ to be different, the investment item that is indicated by the priority area 5 or the investment item that is designated by the user can be identified easily from the other investment items.

Moreover, according to the present embodiment, since the circle display form changing unit 17 is let to change the output format such that the output format of the circles 4₁ to 4₈ of the investment item that is indicated by the priority area 5 or the output format of the circles 4₁ to 4₈ of the investment item that is designated by the user differs from the output format of the circles 4₁ to 4₈ of the other investment items depending on whether the inner portion of the circles 4₁ to 4₈ is colored or not, the investment item that is indicated by the priority area 5 or the investment item that is designated by the user can be identified easily from the other investment items depending on whether the inner portion of the circles 4₁ to 4₈ is colored or not.

Furthermore, according to the present embodiment, since the circle display form changing unit 17 is let to change the output format such that the output format of the circles 4₁ to 4₈ of the investment item that is indicated by the priority area, or the output format of the circles 4₁ to 4₈ of the investment item that is designated by the user differs from the output format of the circles 4₁ to 4₈ of the other investment items according to the difference in the color of the circles 4₁ to 4₈, the investment item that is indicated by the priority area 5 or the investment item that designated by the user can be identified easily according to the difference in color of the circles 4₁ to 4₈.

Moreover, according to the present embodiment, since the circle non-display processing unit 18 is not let to output the circles 4₁ to 4₈ of the investment item other than the investment item that is indicated by the priority 5 area that is output or the investment item other than the investment item that is designated by the user, by not displaying the circles of the investment item that is not a focus of attention, the circles of the investment item on which attention is to be focused can be let to be observed easily.

Furthermore, according to the present embodiment, the trajectory estimating unit 19 is let to estimate the future position of the circles 51₁ to 51₅ related to the investment item from the change in the time series of the position of the circles 51₁ to 51₅ related to the investment item that is indicated by the priority area that is output, by creating the anticipated trajectory, it is possible to predict the future evaluation of the investment item.

Moreover, according to the present embodiment, since the trajectory divergence detecting unit 20 is let to output information that indicates that the position of the circles 5₁ to 51₅ is diverged when the position of the circles 51₁ to 51₅ has diverged from the position of the circles 51₁ to 51₅ that is estimated by a predetermined amount, if the position of the circles 51₁ to 51₅ of the investment item is diverged by the predetermined amount due to unexpected circumstances, the divergence can be detected efficiently.

Furthermore, according to the present embodiment, since the priority-area deviation detecting unit 21 is let to calculate the timing at which the anticipated trajectory 52 that is estimated deviates to the outside of the priority area 5, the timing at which the anticipated trajectory 52 deviates from the priority area 5 and that investment item goes off the investment item that is to be regarded as important, can be predicted efficiently.

Moreover, according to the present embodiment, since the item list output unit 22 is let to output the classification total of the business evaluation score and the classification total of the technical evaluation score which are the evaluation values of the investment item for which the circles 4₁ to 4₈ are output in the portfolio chart 1, as the item list 60 for each quadrant in the portfolio chart 1, it is possible to understand the accurate evaluation value of the investment item by listing up as the item list 60.

Furthermore, according to the present embodiment, since the item list output unit 22 is let to output the evaluation value of the investment item for each quadrant in the portfolio chart 1 that are rearranged based on the degree of satisfaction of the conditional expression that is stored in the conditional expression data 12g as the item list 60, it is easy to verify the evaluation value etc. of the investment item that is to be regarded as important for which the degree of satisfaction of the conditional expression is high, by rearranging the evaluation value of the investment item according to the degree of satisfaction of the conditional expression that is stored in the conditional expression data 12g.

Moreover, according the present embodiment, since the query executing unit 13 and the score summing unit 14 let the evaluation value of the investment item to be multiplied by the weight coefficient, and the chart creating unit 15 is let to output the circles 4₁ to 4₈ that express an evaluation of the investment item based on the evaluation value that is multiplied by the weight coefficient, even a case where there is a change in the evaluation policy of the investment item according to the user or the timing can be dealt with easily by changing the weighting of the evaluation value according to the user or the timing.

Although the embodiment of the present invention has been described so far, the present invention may also be executed for various different embodiments which fall within a range of technical ideas that are described in claims, apart from the embodiment mentioned above.

Furthermore, from among the processes described in the present embodiment, a part of processes or all processes that are described to have been performed automatically can by performed manually, or a part of processes or all processes that are described to have been performed manually can be performed automatically by a known method.

Apart from this, processing units, controlling units, concrete names, and information that include various data and parameters shown in this document and diagrams can be changed voluntarily except when mentioned specially.

Moreover, each component of the evaluation result output unit shown in the diagrams is a functional conception, and it is not necessarily required to be configured physically as shown in the drawing. In other words, a concrete form of distribution and integration of the evaluation result output unit is not restricted to that shown in the diagram, and a part of it or the whole of it can be configured by distributing and integrating functionally or physically in voluntary units according to load and using conditions.

Furthermore, a voluntary part of each processing function or the whole of each processing function that is performed by the evaluation result output unit can be realized by a CPU and a computer program that is analyzed and run by the CPU, or can be realized as hardware by a wired logic.

According to the present invention, since setting conditions of a specific area that indicates a specific target to be evaluated in a chart is stored and based on the setting conditions that are stored, the specific area and a position of coordinates of the target to be evaluated in the chart are let to be output, by outputting the specific area that indicates the specific target to be evaluated such as a target to be evaluated that is to be regarded as important and not just showing the position of coordinates of the target to be evaluated, the specific target to be evaluated is let to be easily understandable, thereby supporting strongly a decision making performed by a user.

Furthermore, according to the present invention, since an output format is let to be changed such that an output format of the position of coordinates of the target to be evaluated that is indicated by the specific area that is output or an output format of a position of coordinates of a target to be evaluated that is designated by the user differs from an output format of a position of coordinates of other target to be evaluated, by letting the output formats to be different, the target to be evaluated that is indicated by the specific area or the target to be evaluated that is designated by the user can be distinguished easily from the other target to be evaluated.

Moreover, according to the present invention, when the position of coordinates of the target to be evaluated is output by using a predetermined graphic form, since the output format is let to be changed such that the output format of the position of coordinates of the target to be evaluated that is indicated by the specific area that is output or the output format of the position of coordinates of the target to be evaluated that is designated by the user differs from the output format of the position of coordinates of the other target to be evaluated depending on whether an inner portion of the graphic form is colored or not, the target to be evaluated that is indicated by the specific area or the target to be evaluated that is designated by the user can be distinguished easily from the other target to be evaluated depending on whether the inner portion of the graphic form is colored or not.

Furthermore, according to the present invention, when the position of coordinates of the target to be evaluated is output by using the predetermined graphic form, since the output format is let to be changed such that the output format of the position of coordinates of the target to be evaluated that is indicated by the specific area that is output or the output format of the position of coordinates of the target to be evaluated that is designated by the user differs from the output format of the position of coordinates of the other target to be evaluated according to a difference in color of the graphic form, the target to be evaluated that is indicated by the specific area or the target to be evaluated that is designated by the user can be distinguished easily from the other target to be evaluated according to the difference in color.

Moreover, according to the present invention, since a position of coordinates of a target to be evaluated other than the target to be evaluated that is indicated by the specific area that is output or a position of coordinates of a target to be evaluated other than the target to be evaluated that is designated by the user is not let to be output, by not displaying a target to be evaluated that is not a focus of attention, a position of coordinates of a target to be evaluated that is a focus of attention can be let to be observed easily.

Furthermore, according to the present invention, since a future position of coordinates of the target to be evaluated is let to be estimated from a change in a time series of the position of coordinates of the target to be evaluated that is indicated by the specific area that is output, it is possible to predict a future evaluation of the target to be evaluated.

Moreover, according the present invention, since information that indicates that the position of coordinates is let to be diverged when the position of coordinates of the target to be evaluated is diverged by a predetermined amount from an estimated position of coordinates, if the position of coordinates of the target to be evaluated is diverged by the predetermined amount due to unexpected circumstances, the divergence can be detected efficiently.

Furthermore, according to the present invention, since a timing of deviation of the position of coordinates that is estimated to be outside the specific area is let to be calculated, the timing at which the position of coordinates of the target to be evaluated deviates and target to be evaluated goes off the target to be evaluated that is to be regarded as important, can be predicted efficiently.

Moreover, according to the present invention, since evaluation values of targets of evaluation for which the position of coordinates are let to be output in the chart are output as a list for each predetermined area in the chart, it is possible to understand by listing up an accurate evaluation value of each target to be evaluated.

Furthermore, according to the present invention, since the evaluation values of the target to be evaluated for each predetermined area in the chart are let to be output as a list that is rearranged based on a degree of satisfaction of the setting conditions, it is possible to verify an evaluation value of a target to be evaluated that is regarded as important that has setting conditions with a high degree of satisfaction, by rearranging the evaluation value of each target to be evaluated according to a degree of satisfaction of setting conditions of the specific area.

Moreover, according to the present invention, since the position of coordinates of the target to be evaluated is let to be output based on an evaluation value weighted upon assigning weight to the evaluation value of the target to be evaluated, even a case where there is a change in an evaluation policy according to the user or the timing can be dealt with easily by changing the weighting of the evaluation value according to the user or the timing.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

### INDUSTRIAL APPLICABILITY

Thus, a computer program to output evaluation result according to the present invention is useful for an evaluation result output system in which a judgment making performed by a user is required to be supported strongly.

What is claimed is:

1. A computer-readable recording medium that stores a computer program for outputting an evaluation result of a target to be evaluated by positioning the target on a chart that is formed with a plurality of coordinate axes that determine an evaluation value of the target, wherein the computer program makes a computer execute
storing setting conditions of a specific area that indicates a specific target to be evaluated on the chart; and
outputting the specific area and a position of coordinates of the target on the chart based on the setting conditions stored at the storing.

2. The computer-readable recording medium according to claim 1, wherein the computer program further makes the computer execute changing an output format in such a manner that an output format of the position of coordinates of the target indicated by the specific area, which is output at the outputting, or an output format of a position of coordinates of a target designated by a user differs from an output format of a position of coordinates of other target.

3. The computer-readable recording medium according to claim 2, wherein when the position of coordinates of the target is output in a form of a predetermined graphic, the changing includes changing the output format in such a manner that the output format of the position of coordinates of the target indicated by the specific area or the output format of the position of coordinates of the target designated by the user differs from the output format of the position of coordinates of the other target based on whether an inside the predetermined graphic is colored.

4. The computer-readable recording medium according to claim 2, wherein when the position of coordinates of the target is output in a form of a predetermined graphic, the changing includes changing the output format in such a manner that the output format of the position of coordinates of the target indicated by the specific area or the output format of the position of coordinates of the target designated by the user differs from the output format of the position of coordinates of the other target based on a difference in a color of the predetermined graphic.

5. The computer-readable recording medium according to claim 1, wherein the computer program further makes the computer execute blocking an output of the position of coordinates of the target other than the target indicated by the specific area, which is output at the outputting, or the target designated by the user.

6. The computer-readable recording medium according to claim 1, wherein the computer program further makes the computer execute estimating future coordinates of the target from a time-dependent change of the coordinates of the target indicated by the specific area, which is output at the outputting.

7. The computer-readable recording medium according to claim 6, wherein the computer program further makes the computer execute outputting information indicating that the position of coordinates is diverged when the position of coordinates of the target is diverged from the position of coordinates estimated at the estimating by a predetermined amount.

8. The computer-readable recording medium according to claim 6, wherein the computer program further makes the computer execute calculating a timing at which the position of coordinates estimated at the estimating is deviated outside the specific area.

9. The computer-readable recording medium according to claim 1, wherein the computer program further makes the computer execute outputting an evaluation value of the target of which the position of coordinates is output at the outputting the specific area and the position of coordinates of the target, as a list table for each of predetermined areas on the chart.

10. The computer-readable recording medium according to claim 9, wherein the outputting an evaluation value includes
sorting the estimation value of the target for each of the predetermined areas on the chart based on a level of satisfaction of the setting conditions of the specific area to make the list table; and
outputting the list table in which the estimation value is sorted.

11. The computer-readable recording medium according to claim 1, wherein the outputting the specific area and the position of coordinates of the target includes
weighting the evaluation value of the target; and
outputting the position of coordinates of the target based on the evaluation value weighted.

12. An apparatus for outputting an evaluation result of a target to be evaluated by positioning the target on a chart that is formed with a plurality of coordinate axes that determine an evaluation value of the target, the apparatus comprising:
a setting-condition storing unit that stores setting conditions of a specific area that indicates a specific target to be evaluated on the chart; and
an area output unit that outputs the specific area and a position of coordinates of the target on the chart based on the setting conditions stored at the storing.

13. A method of outputting an evaluation result of a target to be evaluated by positioning the target on a chart that is formed with a plurality of coordinate axes that determine an evaluation value of the target, the method comprising:
storing setting conditions of a specific area that indicates a specific target to be evaluated on the chart; and
outputting the specific area and a position of coordinates of the target on the chart based on the setting conditions stored at the storing.
